(19) United States
(12) Patent Application Publication
(10) Pub. No.: US 2016/0074908 A1
(43) Pub. Date: Mar. 17, 2016

(54) VIBRATING SCREEN

(71) Applicant: FLSMIDTH A/S, Vaby (DK)

(72) Inventor: Christopher Gordon, Yeronga (AU)

(21) Appl. No.: 14/787,549

(22) PCT Filed: May 1, 2013
(86) PCT No.: PCT/IB2013/053427

§ 371 Date: Oct. 28, 2015

(51) Int. Cl. B07B 1/28; B07B 1/46

(52) U.S. Cl. CPC B07B 1/28; B07B 1/46

(57) ABSTRACT

Disclosed herein are embodiments of a vibrating screen (10) for separation of materials by size. The vibrating screen (10) may include a chassis (100) with side walls (102) and a plurality of support members (104A, 104B); a vibrator (126) that generates vibrations; at least one screen panel (120A, 120B) mounted to the chassis (100); where a screen mounting system is used that includes an upper surface that is angled relative to the adjacent screen panel (120A, 120B).

### FIELD OF THE INVENTION

The invention relates to a vibrating screen. In particular, although not exclusively, the invention relates to a vibrating screen for separation of materials such as ores in mining and mineral processing with a high clearance below the screening panels.

### BACKGROUND TO THE INVENTION

Vibrating screens are typically used in the mining and mineral processing industries to separate materials, such as coal, by size. A vibrating screen typically has a chassis with screen panels. The chassis is typically rigid with various support members to ensure structural integrity. The chassis is mounted on springs, or the like, and has vibrators which cause the chassis, and therefore the screen panels, to vibrate. The screen panels have apertures which allow smaller sized material to pass through. In use, the chassis vibrates and material is passed over the screen panels and smaller material is separated from larger material as it passes through the apertures in the screen panels.

Typically the screen panels are releasably mounted to stringers which extend longitudinally along the vibrating screens. The stringers are mounted in crossbeam portions of the chassis which pass underneath the panels between two side walls. Some material that passes through the apertures impacts with the crossbeam portions. The collision can cause wear to the crossbeam reducing its structural integrity.

Furthermore, material can get jammed between the crossbeams and the screen panels and smaller material may settle on the crossbeams which, over time, may accumulate. Both of these outcomes reduce the clearance between the screens and the crossbeams. The reduced clearance can limit the size of particles that can pass through the screens and studies have shown that they can cause significant blocking of the screens. This effectively renders a portion of the screen unusable and therefore reduces the efficiency of the screen. This leads to greater energy usage and/or the material not being separated effectively. Additionally, the screen panels may also need to be replaced prematurely due to the blockages. This in turn increases costs and down time, further reducing efficiency.

It will be clearly understood that any reference herein to background material or information, or to a prior publication, does not constitute an admission that any material, information or publication forms part of the common general knowledge in the art, or is otherwise admissible prior art, whether in Australia or in any other country.

### OBJECT OF THE INVENTION

It is an object of the invention to overcome or at least alleviate one or more of the above problems and/or provide the consumer with a useful or commercial choice.

Other objects of the present invention will become apparent from the following description.

### DISCLOSURE OF THE INVENTION

In one form, although it need not be the only or indeed the broadest form, the invention resides in a vibrating screen comprising:

a chassis including two side walls with a plurality of support members therebetween and a screen mounting system;

at least one vibrator that generates vibrations in the chassis; and

at least one screen panel mounted to the screen mounting system of the chassis;

wherein the screen mounting system includes at least one stringer mounted to an extension member that extends upwardly from the support members.

The support member may have an upper surface that is angled relative to adjacent screens. The upper surface of the support member may be declined with respect to a material flow direction across the adjacent screens. The support member may comprise an upper portion and a lower portion separated by a web portion. The upper and lower portions may be in substantially parallel planes. The web portion is in a substantially perpendicular plane to the upper and lower portions. In a one embodiment, the support member is an ‘I’-beam with an off centre web portion between upper and lower portions. The I-beam may have one or more reinforcing ribs, extending in a plane that is perpendicular to planes of the upper, lower, and web portions.

The upper surface may be an outer surface of the upper portion. The support member may be mounted such that the upper, lower, and web portions are all angled relative to a stringer mounted to an extension member that extends upwardly from the support member. The extension member may displace the stringer away from the support member to provide a high clearance between the screens and the support member. The extension member may have a base portion and an extension portion. The extension portion may be in a substantially perpendicular plane to the base portion.

The base portion may engage with the upper portion of the support member and, in one embodiment, the extension portion may engage with at least one stringer. The base portion and/or the extension portion may include apertures. The apertures may be utilized to fasten the base portion to the support portion of the support member and the extension portion to the at least one stringer. In one embodiment, the extension portion has a plurality of apertures aligned along an axis that is angled relative to a plane of the base portion. Alternatively it will be appreciated that the extension member may be integral with the stringer and/or support member.

At least a portion of the support member may have a wear resistant coating. The wear resistant coating may be applied to at least a portion of the upper surface and/or at least a portion of a surface of the web portion. The web portion may be angled relative to the screen panels such that a surface of the web portion is angled generally towards the screens and another parallel surface of the web portion is angled generally away from the screens. At least a portion of the surface of the web portion that is angled generally toward the screens may have the wear resistant coating. The wear resistant coating may be substantially rubber or ceramic.

The vibrating screen may further comprise one or more struts located between adjacent extension members. The struts may include mounting portions separated by a strut portion. The mounting portions may be mounting plates which are mounted to the strut portion. The mounting plates may include apertures. At least one aperture of the mounting plate may correspond to at least one aperture of the extension member, which may be of the extension portion of the extension member.

In another form, the invention resides in a vibrating screen comprising:

a chassis including two side walls with a plurality of support members therebetween and a screen mounting system;

at least one vibrator that generates vibrations in the chassis; and

at least one screen panel mounted to the screen mounting system of the chassis;

wherein an upper surface of at least a portion of the support members is angled relative to adjacent screen panels.

The upper surface of at least a portion of the support members and the adjacent screen panels may define a tapered opening therebetween. Further features of the present invention will become apparent from the following detailed description.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, wherein:

FIG. 1 is a perspective view of a vibrating screen according to an embodiment of the invention;

FIG. 2 is a cross sectional view of the vibrating screen illustrated in FIG. 1;

FIG. 3 is a close up view of a portion of FIG. 2;

FIG. 4 is a perspective cross sectional view of the vibrating screen illustrated in FIG. 1;

FIG. 5 is a perspective view of a support member according to an embodiment of the invention;

FIG. 6 is a perspective view of an extension member according to an embodiment of the invention; and

FIG. 7 is a perspective view of a strut according to an embodiment of the invention.

### DETAILED DESCRIPTION OF THE INVENTION

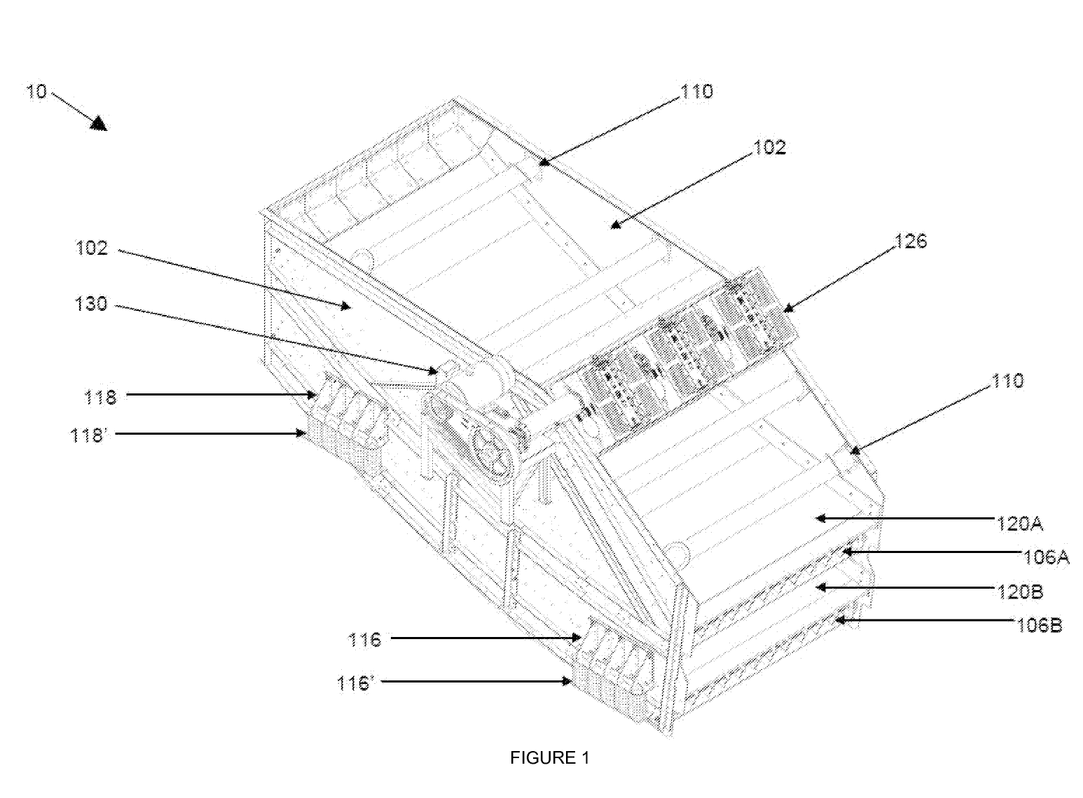

FIGS. 1 to 4 illustrate a vibrating screen 10 having a chassis 100 with two opposed side walls 102, support members in the form of upper crossbeams 104A and lower crossbeams 104B, with an upper and lower screen mounting system including a plurality of upper stringers 106A and a plurality of lower stringers 106B. The vibrating screen 10 has an upper deck comprising a plurality of upper screen panels 120A mounted to the upper stringers 106A, and a lower deck comprising a plurality of lower screen panels 120B mounted to the lower stringers 106B.

The vibrating screen 10 has two lifting beams 110 which can be used to lift and manoeuvre the vibrating screen 10, typically with a crane (not shown). A vibrator reinforcing beam 112 is mounted between the side walls 102 with vibrators in the form of exciters 126 mechanically linked to a drive assembly 130. Affixed to an outer surface of each side wall 102 is a front spring mount 116 and a rear spring mount 118 with front springs 116′ and rear springs 118′, respectively. In use the springs 116′ and 118′ are mounted on stands (not shown).

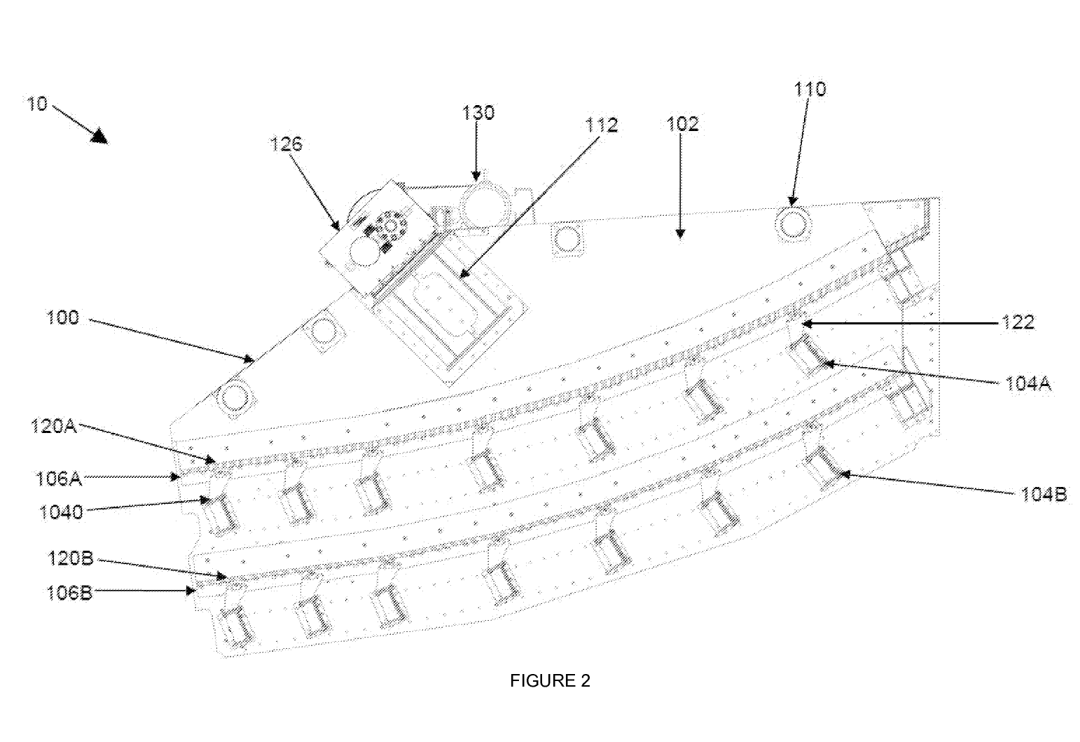

As illustrated in FIG. 2, the upper stringers 106A and lower stringers 106B are mounted to the cross beams 104A and 104B via extension members 122. The extension members 122 are mounted to an upper surface of an upper portion 1040 of the cross beams 104A and 104B and are mounted to stringers 106A and 106B. The extension member 122 mounting to the stringer 106A and 106B is vertically offset from the mounting to the cross beams 104A and 104B. Furthermore, the extension members 122 are configured such that upper surface of the upper portion 1040 of the cross beams 104A and 104B are angled relative to the respective stringers 106A and 106B that the extension member 122 is mounted to. As the screen panels 120A and 120B are mounted directly to the stringers 106A and 106B, such that they are in parallel planes, this results in the upper surface of the upper portion 1040 of the cross beams 104A and 104B to also be angled relative to adjacent screen panels 120A and 120B.

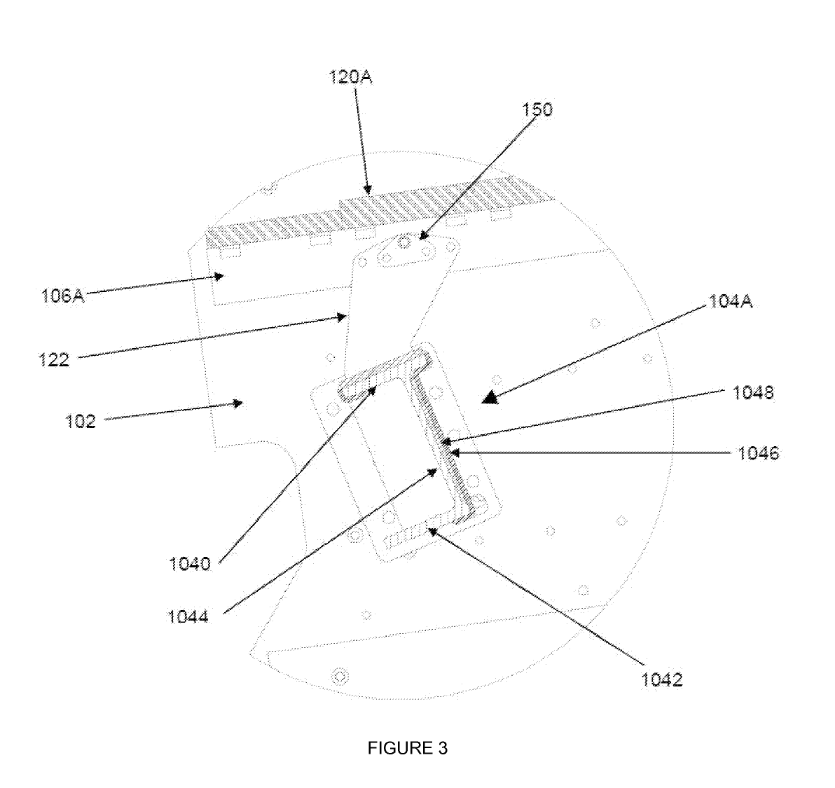

FIG. 3 illustrates a cross beam 104A and an extension member 122 in greater detail. The cross beam 104A has an upper portion 1040 and a lower portion 1042 separated by a web portion 1044. The cross beam 104A generally represents resembles an ‘I-beam’ with an off centre web portion 1044. Selected surfaces of the cross beam 104A have a wear resistant coating 1046 which is typically rubber or a rubber based compound. Notably, the exterior surfaces that generally face the screen panels 120A, being surfaces which are more likely to be impacted from material passing through adjacent screen panels 120A, have the wear resistance coating 1046 applied thereto. A wear plate 1048 is located between particularly high wear portions of the wear resistant coating 1046 and the cross beam 104A to provide additional protection to the cross beam 104A should the wear resistant coating 1046 be compromised.

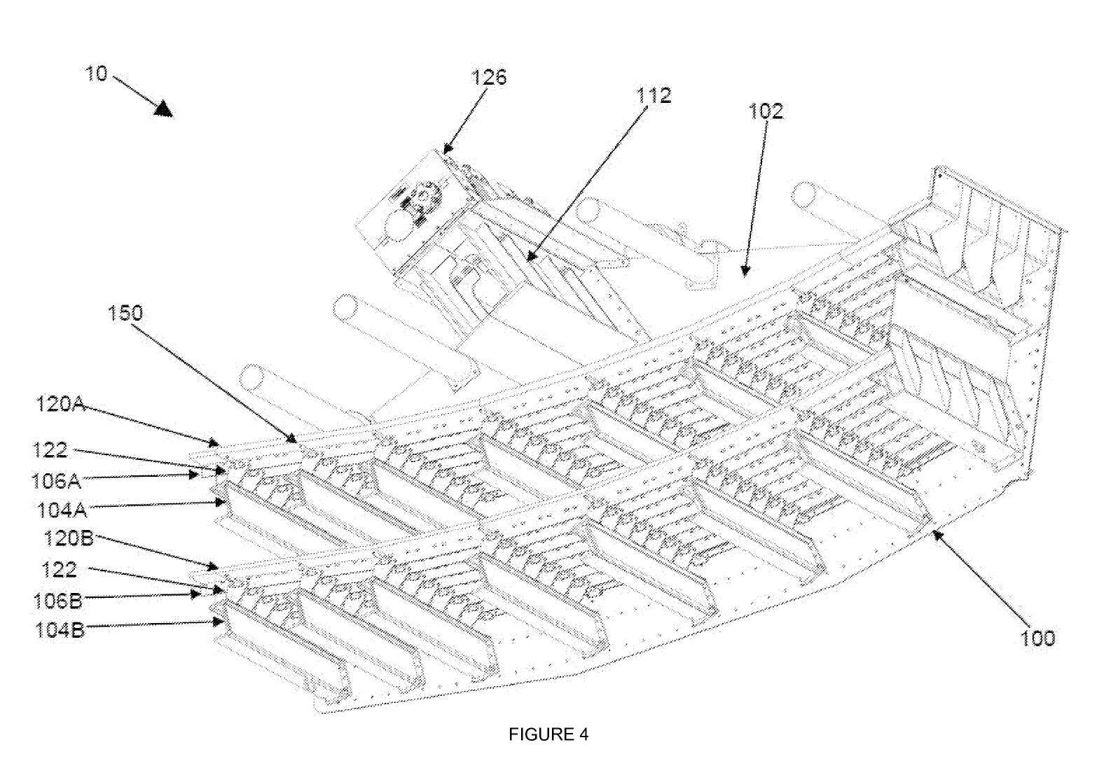

FIG. 4 illustrates an underside cross-sectional view of the vibrating screen 10. The upper and lower cross beams 104A and 104B each have sets of extension members 122 extending upwardly therefrom to the stringers 106A and 106B. Located between adjacent extension portions 1222 of the extension members 122 are struts 150 that are mounted with the extension members 122 to the stringers 106A and 106B.

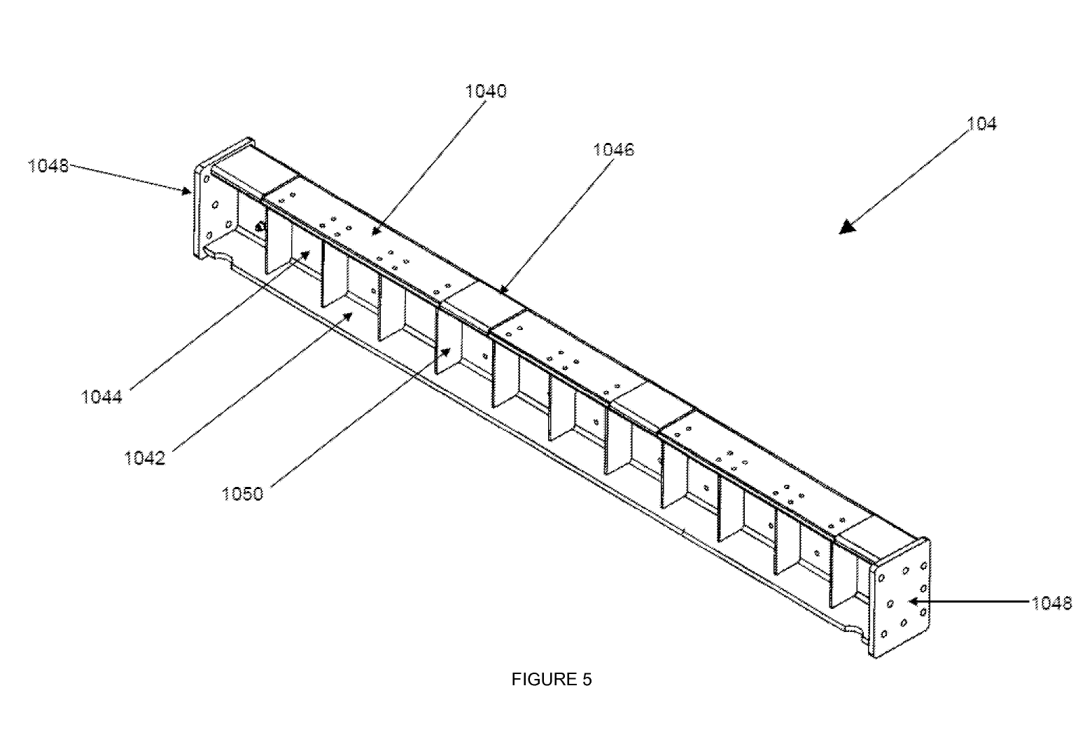

FIG. 5 illustrates a crossbeam 104, which could be an upper crossbeam 104A or lower crossbeam 104B, in isolation. The cross beam 104 has an upper portion 1040 and a lower portion 1042 separated by a web portion 1044. The upper portion 1040, lower portion 1042, web portion 1044 extend the length of the crossbeam 104 between two end plates 1048 that are used to affix the cross beams to the side walls 102 of the vibrating screen 10 (as shown in FIG. 4). Between the upper portion 1040 and lower portion 1042 in parallel planes that are substantially perpendicular to the planes of the upper portion 1040 and lower portion 1042 as well as the plane of the web portion 1044, are reinforcing ribs 1050 that strengthen the crossbeam 104. As shown in FIG. 5, the wear resistant coating 1046 is only applied to portions of the upper surface of the upper portion 1040, with un-coated portions being sized to receive extension members 122.

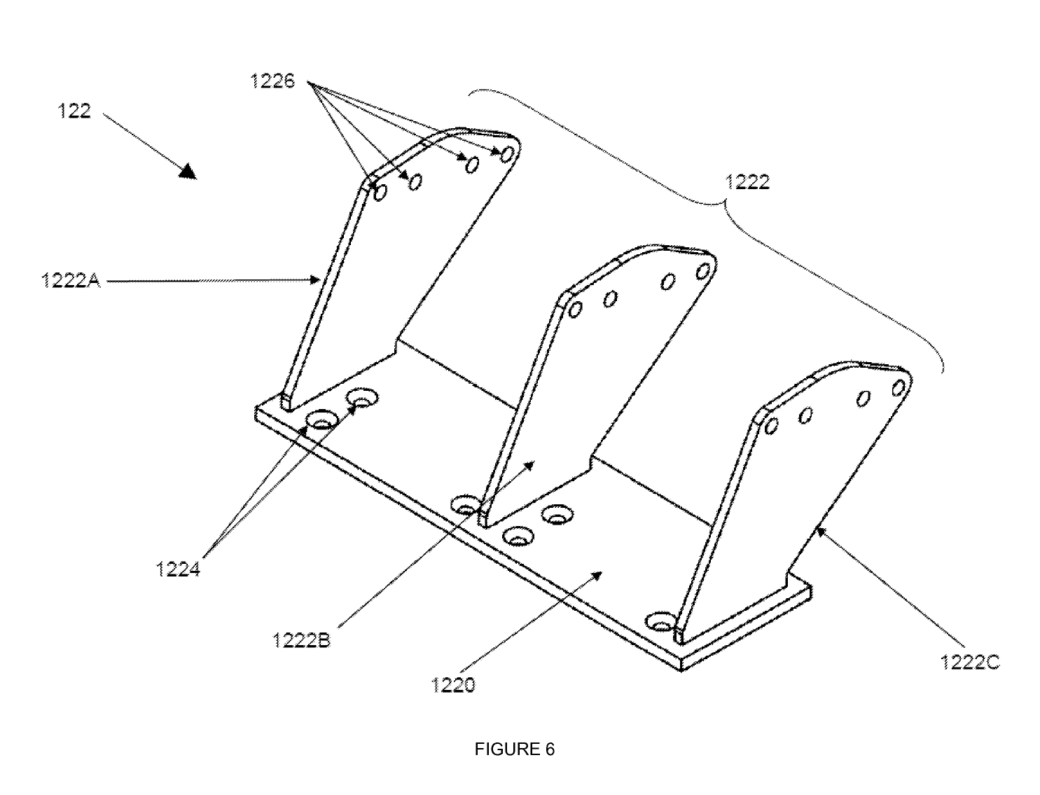

FIG. 6 illustrates an extension member 122 having a base portion 1220 with extension portions 1222 extending substantially perpendicularly therefrom. Notably, the extension member 122 has three extension portions 1222A, 1222B, and 1222C extending therefrom. Each extension portion 1222A, 1222B, and 1222C are generally planar wedge shapes which are of constant thickness.

The base portion 1220 has a plurality of apertures 1224 which are arranged to correspond with apertures in the upper portion 1040 of the crossbeams 104 for mounting thereto. The extension portions 1222 also have a plurality of apertures 1226 which are arranged to correspond with apertures in the stringers 106A and 106B. The extension portion apertures 1226 are aligned along an axis which is angled relative to the base portion 1220 (seen most clearly in FIG. 3).

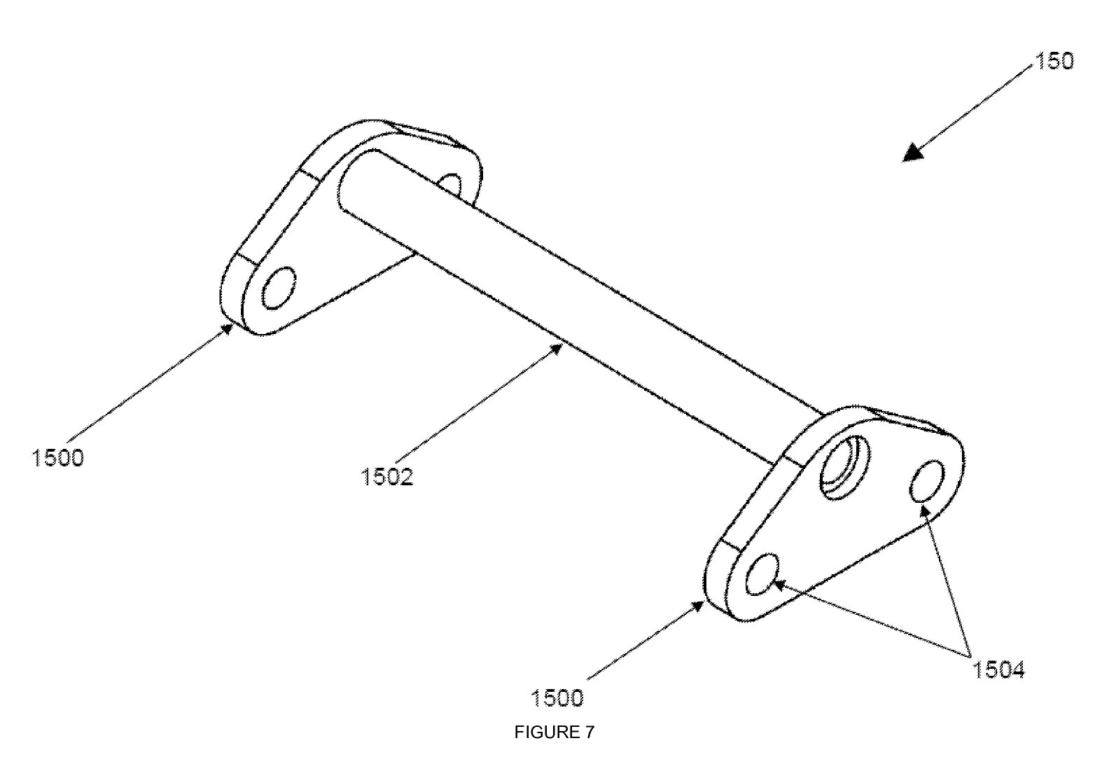

FIG. 7 illustrates a strut 150 having two end mounts 1500 separated by a bar 1502. Each end portion 1500 has a pair of apertures 1504 which correspond to a portion of the extension portion apertures 1226. As illustrated in FIG. 3, the strut 150 is mounted to the extension portion 1222 of the extension member 122. As illustrated in FIG. 4, each strut 150 is mounted between adjacent pairs of extension members 122 and corresponding stringers 106A and 106B.

In use, the vibrating screen 10 of the present invention receives material to be separated, typically an ore, and the drive assembly 130 powers the exciters 126 to generate vibratory forces which are transferred to the chassis 100. This in turn transfers the vibratory forces to the side walls 102, the upper and lower crossbeams 104A and 104B, the stringers 106A and 106B and the screen panels mounted thereon 120A and 120B. The vibrating screen 10 is able to vibrate independently of the ground due to the springs 116′ and 118′ which are typically mounted on stands (not shown). As the screen panels 120A and 120B vibrate the material to be separated vibrates and traverses the screen panels 120A and 120B. The material is subsequently separated as smaller particles pass through apertures in the screen panels 120A and 120B and larger particles stay above the screen panels 120A and 120B.

Advantageously the vibrating screen 10 provides a higher clearance between the screen panels 120A and 120B and the crossbeams 104A and 104B than previous screens. The increased clearance makes it more difficult for material to settle on the crossbeams 104A and 104B and block the screen panels 120A and 120B. The angle of the surfaces of the crossbeams 104A and 104B sends any material that lands on the crossbeams 104A and 104B downwards due to gravity. Furthermore, the angle of the crossbeams 104A and 104B relative to adjacent panels 120A and 120B provides a tapered opening that reduces the likelihood of material being trapped as under vibration the material is urged out of the tapered opening.

These features all improve the reliability and efficiency of the vibrating screen 10 as the screen panels 120A and 120B are less prone to blockages and, therefore, screen material more efficiently with less downtime. Furthermore, screen panel replacement can be less frequent resulting in reduced operating costs.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In the present specification and claims (if any), the word “comprising” and its derivatives including “comprises” and “comprise” include each of the stated integers but does not exclude the inclusion of one or more further integers unless the context of use indicates otherwise.

1. A vibrating screen comprising:
a chassis including two side walls with a plurality of support members therebetween and a screen mounting system;
at least one vibrator that generates vibrations in the chassis; and
at least one screen panel mounted to the screen mounting system of the chassis;
wherein an upper surface of at least a portion of the support members is angled relative to adjacent screen panels; and
wherein the entire upper surface of the support members is tapered in one direction and wherein the upper surface of the support members and the adjacent screen panels define a tapered opening therebetween.

2. The vibrating screen of claim 1, wherein the upper surface of the support member is declined with respect to a material flow direction across the adjacent screens.

3. The vibrating screen claim 1, wherein the support member comprises an upper portion and a lower portion separated by a web portion.

4. The vibrating screen of claim 3, wherein the upper and lower portions are in substantially parallel planes and the web portion is in a substantially perpendicular plane to the upper and lower portions.

5. The vibrating screen of claim 3, wherein the upper, lower, and web portions are all angled relative to a stringer mounted to an extension member that extends upwardly from the support member.

6. The vibrating screen of claim 1, wherein the support member comprises a plurality of reinforcing ribs.

7. The vibrating screen of claim 1, wherein the support member comprises a wear resistant coating applied to at least a portion of the support member that is angled generally towards the screens.

8. The vibrating screen of claim 1, wherein the support member is a ‘I’-beam with an off centre web portion between upper and lower portions.

9. The vibrating screen of claim 1, wherein the entire upper surface of the support member is angled relative to adjacent screen panels.

10. The vibrating screen of claim 1, wherein the screen mounting system comprises at least one stringer mounted to an extension member that extends upwardly from the support member.

11. A vibrating screen comprising:
a chassis including two side walls with a plurality of support members therebetween and a screen mounting system;
at least one vibrator that generates vibrations in the chassis; and
at least one screen panel mounted to the screen mounting system of the chassis;
wherein an upper surface of at least a portion of the support members is angled relative to adjacent screen panels;
wherein the support member comprises an upper portion and a lower portion separated by a web portion; and
wherein the upper, lower, and web portions are all angled relative to a stringer mounted to an extension member that extends upwardly from the support member.

12. A vibrating screen comprising:
a chassis including two side walls with a plurality of support members therebetween and a screen mounting system;
at least one vibrator that generates vibrations in the chassis; and
at least one screen panel mounted to the screen mounting system of the chassis;
wherein an upper surface of at least a portion of the support members is angled relative adjacent screen panels; and
wherein the screen mounting system comprises at least one stringer mounted to an extension member that extends upwardly from the support member.
